(19) United States
(12) Patent Application Publication
(10) Pub. No.: US 2006/0247942 A1
(43) Pub. Date: Nov. 2, 2006

(54) Method, system and apparatus for object-event visual data modeling and mining

(75) Inventors: Bryan Payne, Round Rock, TX (US); Christopher Douglas Watts, Austin, TX (US)

Correspondence Address: BAKER BOTTS, LLP, 910 LOUISIANA, HOUSTON, TX, 77002-4995, US

(73) Assignee: Dell Products L.P.

(21) Appl. No.: 11/119,327

(22) Filed: Apr. 29, 2005

(51) Int. Cl. G06Q 99/00

(52) U.S. Cl. 705/1

(57) ABSTRACT

A system and method are provided for facilitating the allocation support resources. One or more information handling systems are provided to analyze data obtained elsewhere. The information can be displayed in a plot of time and history timeline, with specific types of problems indicated by color. If the same type of problem is encountered at nearly the same time, regions or sub-regions of like-colored data will appear and become evident to the user. The user can then select the regions or sub-regions in question and perform additional analysis to determine the underlying cause of the various problems so that maintenance and support services can be allocated in a pro-active manner to preclude future problems, or additional resources assigned to combat the existing problems.

### CROSS REFERENCE TO RELATED APPLICATION

The present application is related to the following co-pending U.S. Patent Applications, namely Ser. No. 10/952546 entitled “System and Method for Managing Data Concerning Service Dispatches” which was filed on 28-Sept.-2004 by Borkowski et. al; Ser. No. 10/952429 entitled “System and Method for Managing Data Concerning Service Dispatches Involving Geographic Features” which was filed on 28-Sept.-2004 by Schmitt et. al Ser. No. 10/952456 entitled “Apparatus and System for Monitoring and Managing Equipment and Services” which was filed on 28-Sept.-2004 by et. al; and [016295.1834] entitled “Proactive Support Process Using Case Activity Rate” which was filed on by Boswell all of which are incorporated herein by reference.

### BACKGROUND

1. Field of the Invention

The present invention relates to control centers.

2. Background of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information processing systems have become more pervasive, they have also become more complex because those systems are tasked more extensively. As a result, failure of the information processing systems can have a significant and deleterious affect on the performance of an organization. As a consequence, companies that manufacture the information processing systems are often asked by their customers to service broken machines.

For years, companies that manufacture information handling systems have strove to provide better customer service, particularly in the event of system failure. While much effort has been expended, customers are still dissatisfied. There is, therefore, a need in the art to help identify problems with information processing systems and reduce the frequency and duration of failures with those systems.

### SUMMARY OF THE INVENTION

The present invention solves the problems inherent in the art by providing a system and method for allocating maintenance and support resources efficiently. Information regarding the number of service calls, their individual type (of problem related to the service call) and the time in which they were received, can be displayed on, for example, a chart or plot on a monitor or paper or other display mechanism. One or more sub-regions (or the entire plot) can be isolated and further synthesized to produce charts, plots, or employ other techniques to illustrate the segregated information. The synthesis can take many forms and employ one or more factors. For example, the synthesis may sift the data for like problems, like machines, and/or like customers. Additional factors in the synthesis can include geographic region, manufacturing dates and the like. The synthesis process can be repeated as many times as necessary to generate additional charts, plots, etc. of the selected data in order to isolate the desired information in a way that simplifies the user's chore of determining what problems are endemic, and facilitate the allocation by the user of support resources.

### BRIEF DESCRIPTION OF THE DRAWINGS

The patent or application file contains at least one drawing executed in color. Copies of this patent or patent application with color drawings will be provided by the Office upon request and payment of the necessary fee.

A more complete understanding of the present disclosure and advantages thereof may be acquired by referring to the following description taken in conjunction with the accompanying drawings, in which like reference numbers indicate like features, and wherein:

FIG. 1 is a block diagram illustrating an information handling system according to the teachings of the present invention.

FIG. 2 is a block diagram illustrating an embodiment the set of service calls as a function of time according to the teachings of the present invention.

FIG. 3 is a block diagram illustrating a subsection of the embodiment illustrated in FIG. 2.

FIG. 4 is a block diagram illustrating a single element of the embodiment illustrated in FIG. 2.

FIG. 5 is a perspective block diagram illustrating a subsection of the embodiment illustrated in FIGS. 2 and 3.

FIG. 6 is color chart illustrating a portion of the implementation according to the teachings of the present invention.

FIG. 7 is a color chart illustrating a zoom embodiment according to the teachings of the present invention.

FIG. 8 is a color chart illustrating an analysis embodiment according to the teachings of the present invention.

FIG. 9 is a color chart illustrating an analysis embodiment according to the teachings of the present invention.

The present disclosure may be susceptible to various modifications and alternative forms. Specific exemplary embodiments thereof are shown by way of example in the drawing and are described herein in detail. It should be understood, however, that the description set forth herein of specific embodiments is not intended to limit the present disclosure to the particular forms disclosed. Rather, all modifications, alternatives, and equivalents falling within the spirit and scope of the invention as defined by the appended claims are intended to be covered.

### DETAILED DESCRIPTION

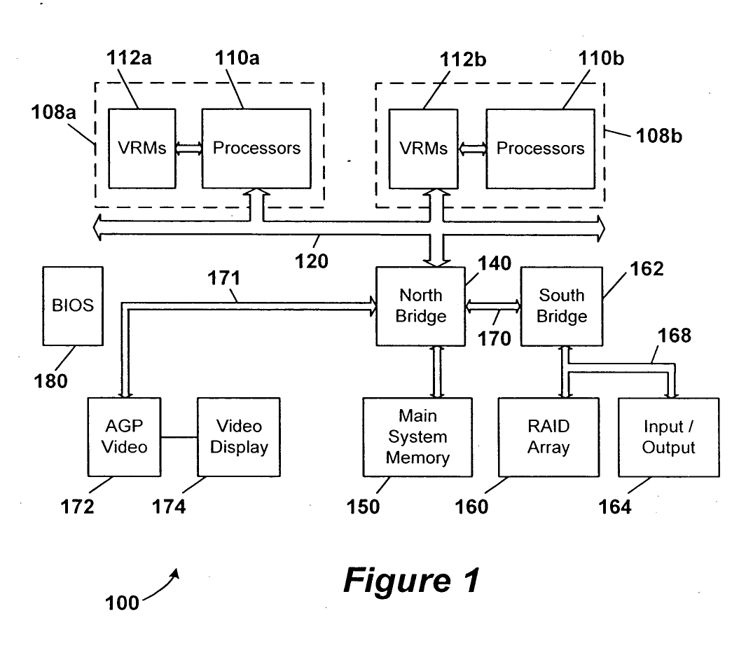

Elements of the present disclosure can be implemented on a computer system, as illustrated in FIG. 1. Referring to FIG. 1, depicted is an information handling system, generally referenced by the numeral 100, having electronic components mounted on at least one printed circuit board (“PCB”) (not shown) and communicating data and control signals there between over signal buses. In one embodiment, the information handling system may be a computer system. The information handling system may be composed processors 110 and associated voltage regulator modules (“VRMs”) 112 configured as processor nodes 108. There may be one or more processor nodes 108, one or more processors 110, and one or more VRMs 112, illustrated in FIG. 1 as nodes 108a and 108b, processors 110a and 110b and VRMs 112a and 112b, respectively. A north bridge 140, which may also be referred to as a “memory controller hub” or a “memory controller,” may be coupled to a main system memory 150. The north bridge 140 may be coupled to the processors 110 via the host bus 120. The north bridge 140 is generally considered an application specific chip set that provides connectivity to various buses, and integrates other system functions such as memory interface. For example, an INTEL™ 820E and/or INTEL™ 815E chip set, available from the Intel Corporation of Santa Clara, Calif., provides at least a portion of the north bridge 140. The chip set may also be packaged as an application specific integrated circuit (“ASIC”). The north bridge 140 typically includes functionality to couple the main system memory 150 to other devices within the information handling system 100. Thus, memory controller functions, such as main memory control functions, typically reside in the north bridge 140. In addition, the north bridge 140 provides bus control to handle transfers between the host bus 120 and a second bus(es), e.g., PCI bus 170 and AGP bus 171, the AGP bus 171 being coupled to the AGP video 172 and/or the video display 174. The display 174 can be a monitor, or the information to be displayed may be sent to another device, such as a printer (not shown). The second bus may also comprise other industry standard buses or proprietary buses, e.g., ISA, SCSI, .USB buses 168 through a south bridge (bus interface) 162. These secondary buses 168 may have their own interfaces and controllers, e.g., RAID Array storage system 160 and input/output interface(s) 164. Finally, a BIOS 180 may be operative with the information handling system 100 as illustrated in FIG. 1. The information handling system 100 can be combined with other like systems to form larger systems. Moreover, the information handling system 100, can be combined with other elements, such as networking elements and or other information handling systems, to form even larger and more complex information handling systems such as, for example, clusters or other enterprise resource planning system, such as an enterprise resource planning portal.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory as described above. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The information handling system described above, or similar systems, may be used to implement the systems and methods described herein. It should be noted that the information handling system needed to implement the methods and systems described herein may be implemented in hardware, in software (in the form of one or more instructions), or in any combination of hardware or software. Moreover, no specific software language is required to implement the systems and methods described herein, and they may be implemented using any desired programming language.

An information and telecommunications center having one or more individuals having access to a command station is provided. The command station typically comprises a computer (such as a personal computer (“PC”)) that is operable with a network. Exemplary networks include, for example, a telecommunications network and a data network, such as the Internet, and the like. The command center may also include with one or more large projection (and/or plasma) screens in a large room, as well as conference facilities, all with access through communications mechanisms such as telephones, facsimile, wireless telegraphy, voice-over IP (“VoIP”), email, etc. to individuals from within multiple organizations, such as an original equipment manufacturer (“OEM”) and one or more third-party vendors that supply parts and/or labor services. One or more of the command stations within the command center may interact and/or manipulate one or more elements of the command center, or one or more resources associated with one or more organizations. Typically, individuals, such as dispatchers or other representatives, will interact with the command center through the command station. However, groups of people may coordinate activities through their respective command stations via the communications capabilities of the command center.

While individuals at the command center handle specific service calls, they may be unaware of trends or circumstances that, if known, would enable them to better service the specific service call. In other words, the ability to detect patterns in the product base would facilitate the optimization of allocating support resources. Moreover, detecting patterns of problems in the product base would enable the rectification of problems with newer machines before they reach the customer, thereby proactively eliminating future problems.

Optimization of support resource allocation and proactive elimination of problems is enhanced by use of the technique described herein and illustratively labeled “data radar.“ Data radar enables individuals with even rudimentary computer skills to perform statistical and data analysis functions. Those functions include: (first) identifying statistically significant patterns in ratio data sets of any size; (second) extracting statistically significant sets of data from a larger set (e.g., data mining); and enabling the user to iterate the first and second functions as many times as possible with the data sets that remain within a larger data set. The resulting data can be displayed graphically, such as with colors and/or shapes to facilitate the recognition of patterns by other software applications or by humans. Indeed, the ability to graphically illustrate the resulting data in the manner disclosed herein enables detection of, for example, the fractal nature of the data, and/or make other trends obvious to the user. Similarly, software applications can be provided with the data and perform an analysis independently of humans. For example, the software application can be instructed to look for trends or similarities of the underlying problems in an automated fashion and, when detected, can signal an alert to a user or another software application or perform some other action.

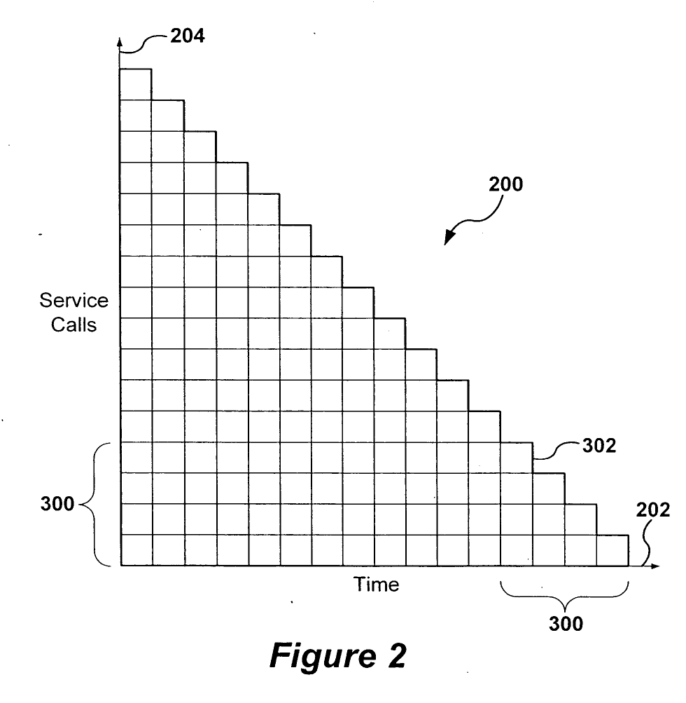

The methodology for analyzing data disclosed herein may be more fully understood by reference to the drawings. FIG. 2 illustrates a set of data 200 along a two dimensional chart having time axis 202 and service call axis 204. Data subset 300 can be segregated from the larger data set 200 as illustrated in FIG. 2. The data can be further subdivided into individual cells 302, and even down to the point of individual case information.

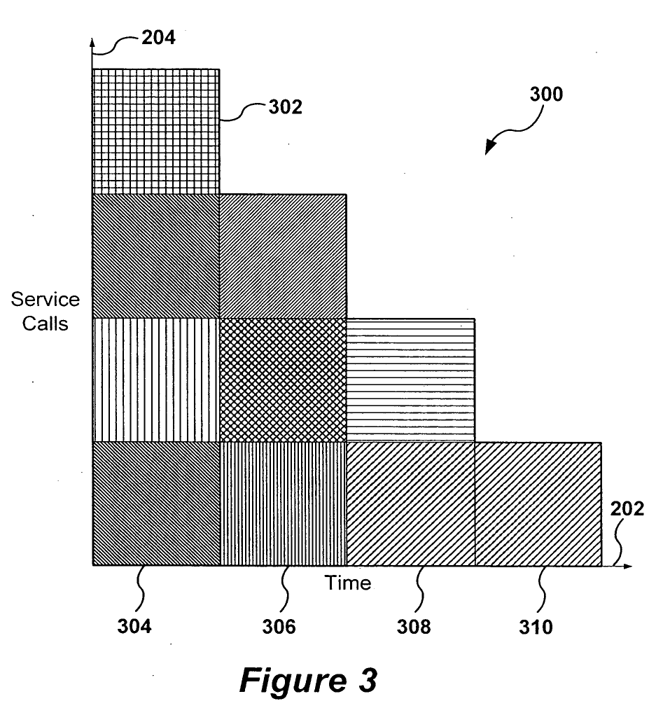

FIG. 3 illustrates the adjustable resolution feature of the present disclosure. In this instance, the lower right region 300 of the larger data set 200 (see FIG. 2) has been segregated for further study. Multiple elements 302, 204, 306, 308, and 310 are viewable, and in one embodiment are distinguished by color. Color enables three-dimensions of information to be displayed on a two-dimensional plot, such as the one illustrated in FIG. 3. The color (for the third-dimension) may be used to indicate any type of information. However, it is particularly useful to display the kind of problem experienced by multiple information handling systems so that enables patterns (and hence more efficient allocation of resources) to emerge.

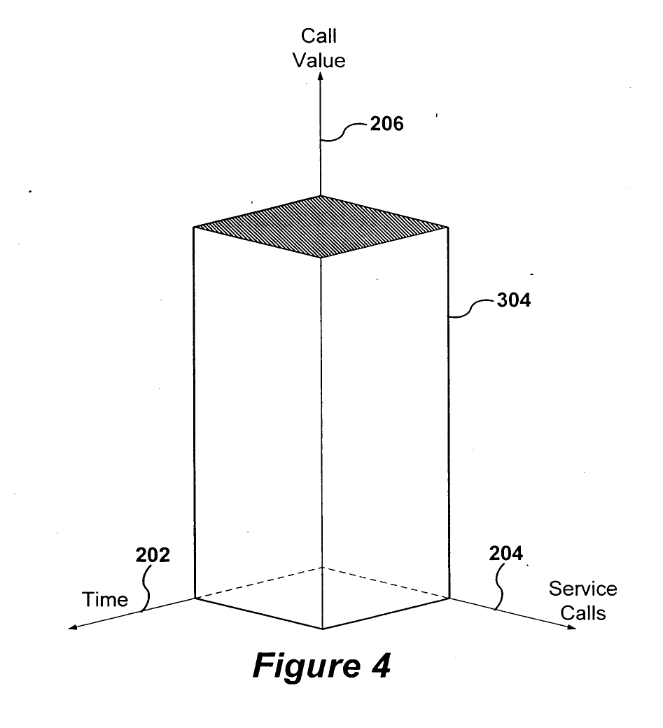

FIG. 4 illustrates one of the information value indicators 304 in a perspective view. The information value indicators can, for example, indicate the type of problem encountered for a particular device or system. The call value 206 of indicator 304 can be displayed as a height (as illustrated in FIG. 4) or as a color (as illustrated in FIG. 3). As mentioned before, call values can indicate a variety of information, for example the specific type of problem encountered, such as a failed hard drive, or failed power supply. The call value may indicate a non-hardware issue, such as an operating system that won't load properly. In another embodiment, the call type may be selectable, so that the call value will change (for the same customer/machine) but the position of the call (i.e., its time 202 and service call history 204 values and thus position on the chart 200 is unchanged. Such selection capability can be very useful for analyzing the type, frequency and timeliness of particular problems.

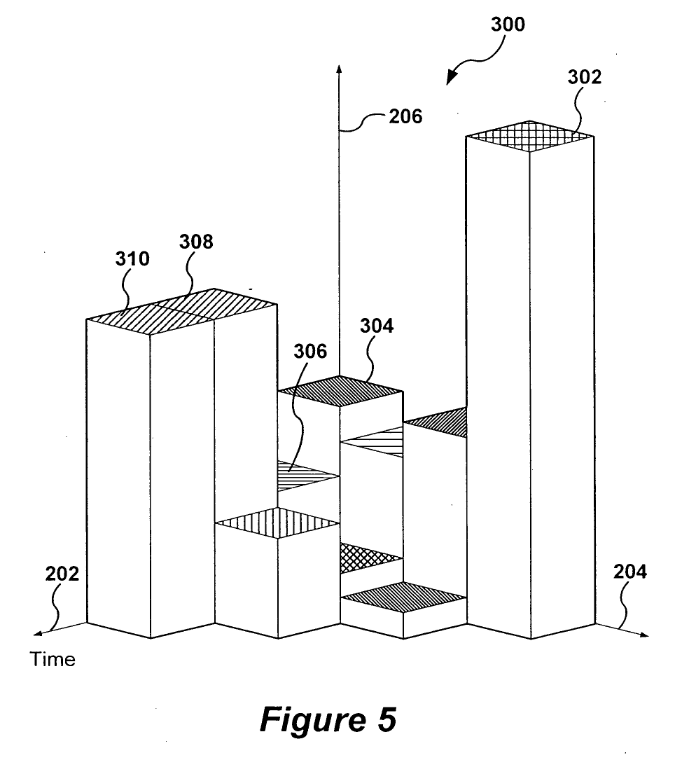

FIG. 5 illustrates the multiple call value indicators of FIG. 3 in the perspective view (analogous to FIG. 4). As illustrated in FIG. 5, the various elements 302, 304, 306, 308 and 310 can have the same or disparate call values 206, with call values of the same height having the same color and call values of disparate height having disparate colors.

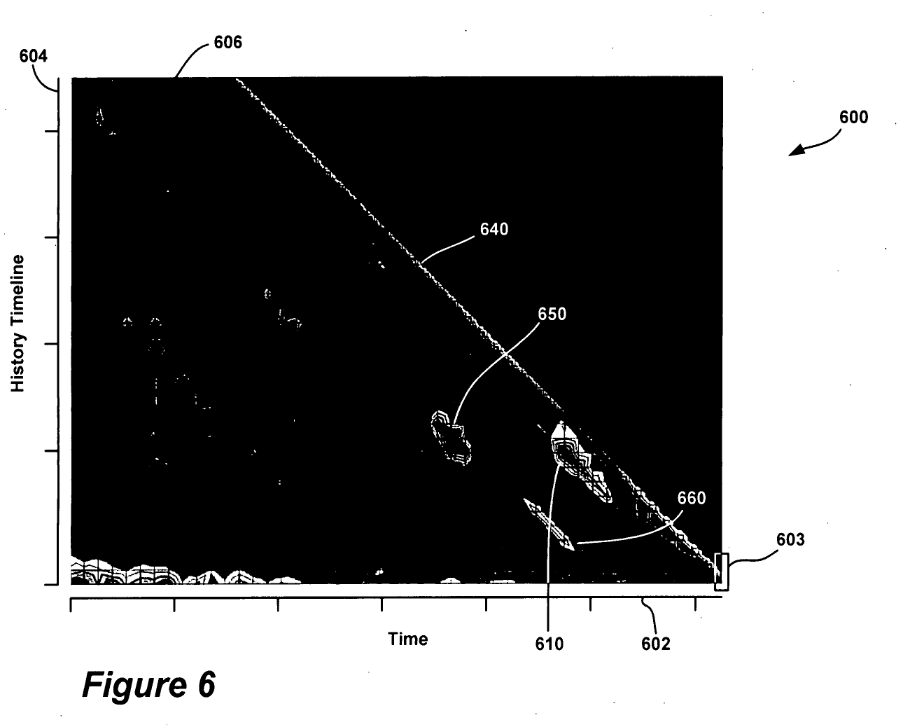

FIG. 6 illustrates the results according to one embodiment of the invention. In this example, the two-dimensional plot 606 is has two axis, namely time 602 and history problem (history) timelines 604. The time axis 602 can be, for example, a simple timeline from the latest date (the present) on the right side an earlier date in the past on the left. The history timeline 604 is the “distance” in time from the time axis 602. In other words, the an increasing value of the history timeline 604 indicates the longer ago in time the service call (at the particular time) was encountered. If the time axis 602 and the history timeline axis 604 have the same unit of measure (e.g., days) then a 45-degree line 640 will be evident as illustrated in FIG. 6. The line 640 represents the machines with the oldest unresolved service issue for any particular point in time 602. Thus, information below the line 640 gives a history of problems requiring a service call. Because of the unique arrangement of time 602 and time histogram 604, patterns of similar problems that are contemporaneous tend to group together. If the particular problem is given a particular color, then contemporaneous problems of a similar nature form groups of colors on the chart 606 that are easily identified by users as indicative of specific problems that can be addressed by remedial or pro-active action.

In typical operation, the more recent is at the right of the plot 606 and previous history segments are toward the left. In other words, the number of current cases is represented by the pixels of the rightmost history timeline (illustrated within box 603). Thus, the call values along the roughly 45 degree line 640 represent the oldest problems. When a problem is first encountered, its history timeline 604 value is low, and at the bottom-right of the plot 606. As time moves on, the pixel indicating the particular problem will move up the history timeline 604 as the longevity of the service call increases. Resolving the problem can result in a change of color (e.g., blue). Similarly, a color can be chosen that illustrates what the solved was (e.g., a failed hard disk), and that the problem was resolved (e.g., light blue).

FIG. 6 illustrates groups of problems, such as regions 610, 650 and 660. Each “problem” is typically color-coded in a particular manner to make identification easy for the user. In other words, when large clumps of problems concern the same underlying condition, such as a bad batch of hard disks, they tend to be clumped together in time, and because they are the same problem, are color coded in the same or similar manner. In those cases, clumps of data tend to have more prominence and create regions 650, 610 and 660 as illustrated in FIG. 6.

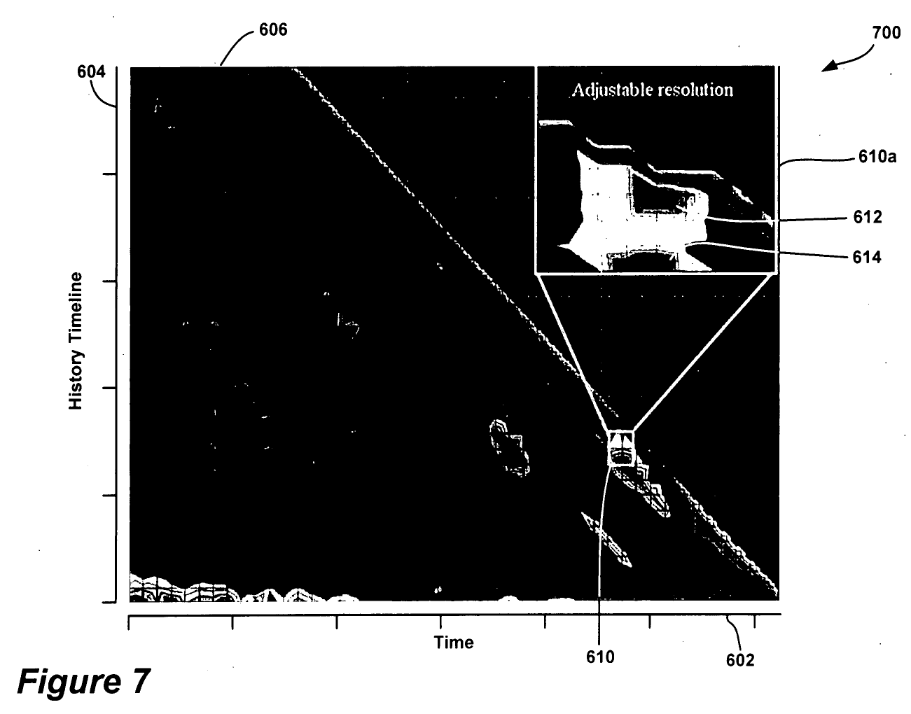

FIG. 7 illustrates an embodiment of the disclosure illustrating adjustable resolution 700, wherein the user zooms in on a sub-region 610a of the region 610. Individual sets of information 612 and 614 can then be viewed in more detail. In yet another embodiment, more detailed information about a particular sub-region can be obtained by the user by, for example, right-clicking their mouse on the desired point in the plot 606 and selecting the desired information from a pop-up menu. Other mechanisms for retrieving additional information are possible with this embodiment.

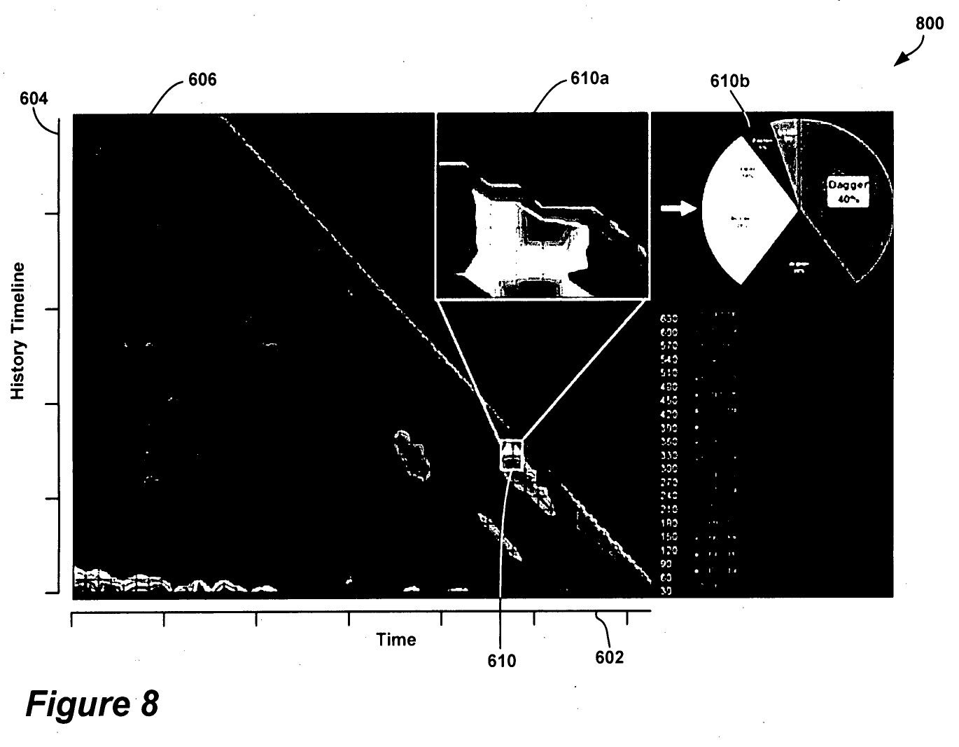

FIG. 8 illustrates the synthesizing 800 of information from the plot 606. Specifically, the zoomed-in sub-region 610a can be analyzed to produce, for example, the pie chart 610b that illustrates the distribution of the issues identified within the sub-region 610a. The pie chart can, for example, match the color coding of the sub-region in question, or may be given different color schemes. Similarly, other types of data display techniques besides pie charts can be used with the methods and system disclosed herein with corresponding effectiveness.

During the synthesis process, information regarding the number of service calls, their individual type (of problem related to the service call) and the time in which they were received, can be displayed on, for example, a chart or plot. One or more sub-regions 610a, the region 610, or the or the entire plot 606 can be isolated and further synthesized to produce charts, plots, or employ other techniques to illustrate the segregated information. The synthesis can take many forms and employ one or more factors. For example, the synthesis may sift the data for like problems, like machines, and/or like customers. Additional factors in the synthesis can include geographic region, manufacturing dates and the like. The synthesis process can be repeated as many times as necessary to generate additional charts, plots, etc. of the selected data in order to isolate the desired information in a way that simplifies the user's chore of determining what problems are endemic, and facilitate the allocation by the user of support resources.

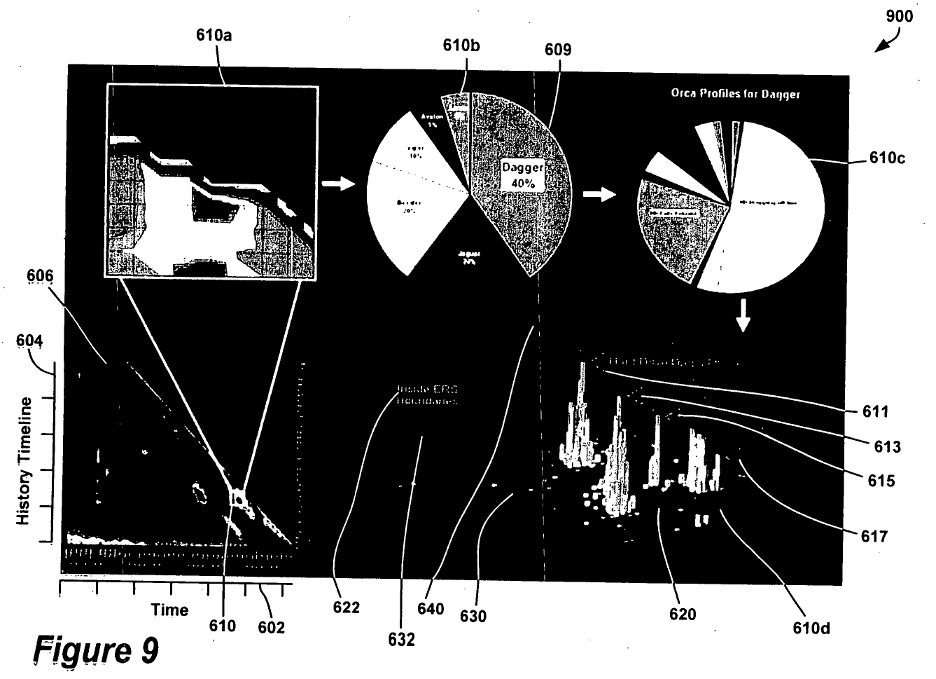

FIG. 9 illustrates additional synthesizing 900 of the data from the sub-region 610a. In this embodiment, the results of the synthesis 800 are further refined to discern specific trends or other information. One portion 609 of the data from the synthesis 800, for example the pie chart 610b, is identified for further analysis by the operator or a computer software program. Once identified, the sub-set of data 609 can be used generate yet another illustrative plot 610c (or other form of information display) that is composed, at least in part, of the subset of data 609. The synthesized data 610c can be further broken down and displayed in yet other illustrative display 610d. In this illustrative example, four peaks 611, 613, 615 and 617 illustrating problems of hard drives dropping offline is illustrated on a plane of concentric rings 620 and 630 which may, for example, illustrate geographic relationship between the machines that experience the particular problem. For example, the ring 620 may indicate a 10-mile radius, and the outer rim 630 indicates a 50-mile radius of some geographic center. Alternatively, the first inner ring 620 may indicate customers having enhanced service contracts, and the outer ring 630 indicating customers with a second level of support services. Labels 622, 632 and 640 can be used to identify and/or explain the information being presented. It will be understood that the information within the plot 606 may be illustrated in many combinations and permutations to enable the user to discern trends and to take pro-active or reactive action and thus better optimize the allocation of support resources.

While a single sub-region 610 was identified for illustration in FIGS. 6-9, it will be understood that a single sub-region is not the only focus of inquiry possible with the disclosed method and apparatus. Indeed, the same type of synthesis can be applied to multiple sub-regions simultaneously and/or over the entire plot 606.

The methods of data display and synthesis 600, 700, 800 and 900 can be implemented on, for example, the information handling system illustrated in FIG. 1. Specifically, the methods can be implemented in a series of one or more software instructions in RAM 150 or on one or more hard disks 160 or other input/output devices 164, such as a floppy disk, CD-ROM, DVD or some other computer-readable medium that can contain a data structure for instructions and/or relevant data (collectively, “instructions”). Alternatively, the instructions to implement the data display and synthesis can be implemented purely in hardware using, for example, application-specific integrated circuits (“ASIC”) or in any combination of hardware and software instructions.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and finction, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1 . A method for displaying information comprising:
providing information regarding a problem;
generating a time axis indicating the time of the problem;
generating a history timeline axis indicating how long ago the problem was encountered;
determining a type for the problem;
assigning an indicator value for the problem; and
displaying the indicator value on a plot of time and history timeline.

2. The method of claim 1, wherein the indicator value is color.

3. The method of claim 1, wherein the indicator value is a height orthogonal to the time axis and the history timeline axis.

4. The method of claim 1, wherein a region is selected by a user.

5. The method of claim 4, wherein the data within the region is subjected to a first synthesis.

6. The method of claim 5, wherein the results of the first synthesis is a second set of data.

7. The method of claim 6, wherein the second set of data is subjected to a second synthesis.

8. The method of claim 5, wherein the data within the region is subjected to a second synthesis.

9. The method of claim 1, wherein a region is selected by a software application.

10. The method of claim 9, wherein the data within the region is subjected to a first synthesis.

11. The method of claim 10, wherein the results of the first synthesis is a second set of data.

12. The method of claim 11, wherein the second set of data is subjected to a second synthesis.

13. The method of claim 10, wherein the data within the region is subjected to a second synthesis.

14. An information handling system having one or more processors, system memory operative with the one or more processors, comprising:
information regarding one or more problems;
instructions executing on the one or more processors for generating a time axis indicating the time of the problem;
instructions executing on the one or more processors for generating a history timeline axis indicating how long ago the problem was encountered;
logic on the one or more processors for determining a type for the problem;
an input device for assigning an indicator value for the problem; and
a display for displaying the indicator value on a plot of time and history timeline.

15. The system of claim 14, wherein the indicator value is color.

16. The system of claim 14, wherein the indicator value is a height orthogonal to the time axis and the history timeline axis.

17. The system of claim 14, wherein a region is selected by a user.

18. The system of claim 17, wherein the data within the region is subjected to a first synthesis.

19. The system of claim 18, wherein the results of the first synthesis is a second set of data.

20. The system of claim 19, wherein the second set of data is subjected to a second synthesis.

21. The system of claim 18, wherein the data within the region is subjected to a second synthesis.

22. The system of claim 14, wherein a region is selected by a software application.

23. The system of claim 22, wherein the data within the region is subjected to a first synthesis.

24. The system of claim 23, wherein the results of the first synthesis is a second set of data.

25. The system of claim 24, wherein the second set of data is subjected to a second synthesis.

26. The system of claim 23, wherein the data within the region is subjected to a second synthesis.

27. A computer-readable medium containing a data structure, comprising:
instructions for providing information regarding a problem;
instructions for generating a time axis indicating the time of the problem;
instructions for generating a history timeline axis indicating how long ago the problem was encountered;
instructions for information determining a type for the problem;
instructions for assigning an indicator value for the problem; and
instructions for displaying the indicator value on a plot of time and history timeline.
